(19) United States
(12) Patent Application Publication
(10) Pub. No.: US 2018/0216363 A1
(43) Pub. Date: Aug. 2, 2018

(54) Rail and Post Assembly

(71) Applicant: Gary W. Ash, Valley Center, CA (US)

(72) Inventor: Gary W. Ash, Valley Center, CA (US)

(21) Appl. No.: 15/852,710

(22) Filed: Dec. 22, 2017

Related U.S. Application Data
(60) Provisional application No. 62/451,451, filed on Jan. 27, 2017.

(51) Int. Cl. E04H 17/14; E06B 11/02

(52) U.S. Cl. CPC E04H 17/1413; E04H 2017/1452; E04H 2017/1465; E06B 11/02

(57) ABSTRACT

A rail and post assembly that allows for onsite fence and gate panel construction is disclosed herein. A shear block is affixed to each end of a rail using an adhesive. The shear block and rail are then fed through an opening in a post. An adhesive secures the shear block to the post, which thereby provides a rail and post assembly.

### CROSS REFERENCE TO RELATED APPLICATIONS

This document claims the benefit of U.S. Prov. Pat. App. No. 62/451,451 filed on Jan. 27, 2017, the entirety of which is hereby incorporated by reference.

### BACKGROUND

This disclosure relates to the general field of fences and gates, and more specifically toward a rail and post assembly that allows for onsite fence and gate panel construction. A shear block is affixed to each end of a rail using an adhesive. The shear block and rail are then fed through an opening in a post. An adhesive secures the shear block to the post, which thereby provides a rail and post assembly.

Fences have been around for thousands of years. From delineating ownership of land to corralling animals, fences play an important role in everyday life. Because of the large demand for fences, there is a great need for versatile fencing materials that produce aesthetically pleasing fences. Construction of the fence should occur quickly and at minimal cost.

To this end, the prior art teaches fences made of extrudable material, such as aluminum or plastic. The materials are cheap and the parts of the fence can be manufactured with little cost. In one embodiment, a fence is created using posts, two or more rails, and a plurality of pickets. The posts are vertically secured to the ground, and the rails are horizontally secured between the posts. The pickets are then vertically secured to the one or more rails. A gate, or a hinged barrier used to close an opening in a fence, has a similar construction to that of a panel of a fence; however, the gate must have a more rigid construction such that it will maintain its shape when supported only by hinges on one of its posts.

To provide sufficient rigidity of a gate and/or fence panel, these panels are often welded together, especially where the rail meets the post. Due to the complexities of welding as well as the tools and material required to weld, gate and fence panels are often welded together at a central manufacturing location, and then shipped to the construction site where they are installed.

However, shipping each panel, and especially multiple panels, is relatively expensive and time consuming. Even if the weight of each panel is not relatively significant, the size and shape often is. The components of a six-foot by four-foot gate may weigh less than thirty pounds, but the oversized dimensions of the prefabricated, welded panel often necessitate extra shipping charges by common carrier. These shipping charges may be three times or more compared to shipping the panel in pieces and assembling it together on site. As stated above, welding onsite is often impracticable, as it requires experienced personnel with specialized tools that in many cases are not readily available, and even if they are available, are usually expensive. In many instances that panel cannot even be welding onsite since the welding can violate the powder coat, which would then require the entire gate to be re-coated.

Further inefficiencies arise when only a single panel of a fence or gate needs to be installed at a location. Generally, when building an entire new fence for a specific location, materials can be constructed and shipped in bulk, which reduces the overall cost of the project. However, when a single panel is to be installed, such as when a previously constructed fence incurs damage to one of its panels or gates, the cost to replace that single panel may be significant, in large part due to the cost of shipping by common carrier.

The prior art teaches a rail and picket assembly that does not require welding. U.S. Pat. No. 8,317,164 to Ash teaches a fence rail that includes a detachable fastener cover that covers and conceals a fastener chamber. Through the use of a knuckle and a catch fastening system, moisture is prevented from entering the fastener chamber. The fastener chamber allows for securing pickets to the rail using a means for fastening as close to the top of the rail as possible thereby allowing for significant racking of the fence. However, this patent publication does not teach or disclose a way to secure the rails to a post without welding.

Thus there has existed a long-felt need for a system and method for constructing a rigid panel onsite without the use of welding, where the panel is strong enough to act as a gate but can be shipped using a small package carrier without unreasonably high fees. The need continues for such a panel that is easily and quickly assembled onsite, whereby individuals without specialized experience may assemble the panel in a timely manner.

### SUMMARY

The current disclosure provides just such a solution by having a rail and post assembly that allows for onsite fence and gate panel construction. A shear block is affixed to each end of a rail using an adhesive. The shear block and rail are then fed through a pass through opening in a post. An adhesive secures the shear block to the back of the post, which thereby provides a rail and post assembly.

It is an object of this disclosure to provide a rail and post assembly that may be assembled without welding at a remote location.

It is another object of this disclosure to provide a rail and post assembly that can be assembled onsite.

It is a further object of this disclosure to provide a rail and post assembly that can be shipped by a small package carrier.

It is an additional object of this disclosure to provide a method for assembling a panel without welding.

It is yet another object of this disclosure to provide a method for assembling a gate panel without welding.

It is a further object of this disclosure to provide a method for assembling a fence panel without welding.

It is an additional object of this disclosure to provide a gate panel that can be shipped by a small package carrier and quickly and easily constructed onsite.

It is another object of this disclosure to provide a fence panel that can be shipped by common a small package and quickly and easily constructed onsite.

An additional object of this disclosure is to provide a rail and post assembly that is constructed with fewer fasteners.

As should be understood by those skilled in the art, when the use of an adhesive is referred to as the same as another adhesive, for example the same adhesive is used to secure to the shear block to the post and the shear block to the rail, it is intended to mean the it is the same type of adhesive, and not that it is the same, physical object used twice.

An embodiment of the current disclosure is a rail and post assembly comprising a post, a rail, a shear block, and an adhesive, where the adhesive secures the shear block to the post, where the post comprises an opening, where the size and shape of the opening is sufficient to allow the rail to extend therethrough, where the shear block is secured to the rail. The shear block is secured to the rail with the adhesive. The adhesive is a methacrylate adhesive. The adhesive is a two-part methacrylate adhesive comprising a methyl methacrylate monomer and a methacrylic acid. The methyl methacrylate monomer is between forty percent (40%) and eight-five percent (85%), inclusive, by weight of the adhesive. The methacrylic acid is between one percent (1%) and eight percent (8%), by weight of the adhesive.

An additional embodiment of the current disclosure is a rail and post assembly comprising a post, where the post comprises a first internal wall, a second internal wall, and an opening, where a first side of the opening is adjacent to the first internal wall, and where a second side of the opening is adjacent to the second internal wall; a rail, where the rail comprises a first side and a second side, where an end of the rail extends through the opening of the post; a first adhesive, where the first adhesive secures the first side of the rail to the first internal wall of the post; and a second adhesive, where the second adhesive secures the second side of the rail to the second internal wall of the post. The first adhesive and second adhesive are each a methacrylate adhesive, and more specifically, a two-part methacrylate adhesive comprising a methyl methacrylate monomer and a methacrylic acid. The methyl methacrylate monomer is between forty percent (40%) and eight-five percent (85%), inclusive, by weight of the adhesive. The methacrylic acid is between one percent (1%) and eight percent (8%), by weight of the adhesive. The first adhesive and the second adhesive consist of the same type of adhesive. The first side of the rail is opposite of the second side of the rail. The rail further comprises a top side, where the top side of the rail connects the first side of the rail to the second side of the rail.

Another embodiment of the current disclosure is a gate or fence panel comprising a first post, a second post, a rail, a first shear block, a second shear block, and an adhesive, where the first shear block is secured to one end of the rail, where the second shear block is secured to another end of the rail, where the first post and second post each comprise an opening, where one end of the rail passes through the opening of the first post, where the other end of the rail passes through the opening of the second post, where the adhesive secures the first shear block to the first post, where the adhesive secures the second shear block to the second post. Each shear block is secured to the rail by the adhesive, or alternatively, each shear block is welded to the rail. Each shear block comprises two ends, where each end is a flat, solid surface. The adhesive is a methacrylate adhesive. The adhesive is a two-part methacrylate adhesive comprising a methyl methacrylate monomer and a methacrylic acid. The methyl methacrylate monomer is between forty percent (40%) and eight-five percent (85%), inclusive, by weight of the adhesive. The methacrylic acid is between one percent (1%) and eight percent (8%), by weight of the adhesive.

In yet another embodiment of the current disclosure, a gate or fence panel is provided comprising a first post, a second post, a rail, and adhesive, where the first post and the second post each comprise a first internal wall, a second internal wall, and an opening, where a first side of the opening is adjacent to the first internal wall, and where a second side of the opening is adjacent to the second internal wall. The rail comprises a first side and a second end, where a first end of the rail extends through the opening of the first post, and where a second end of the rail extends through the opening of the second post. A first adhesive secures the first side of one end of the rail to the first internal wall of the first post. A second adhesive secures the second side of one end of the rail to the second internal wall of the first post. A third adhesive secures the first side of the second end of the rail to the first internal wall of the second post. A fourth adhesive secures the second side of the second end of the rail to the second internal wall of the second post. The adhesives are each a methacrylate adhesive, and more specifically, a two-part methacrylate adhesive comprising a methyl methacrylate monomer and a methacrylic acid. The methyl methacrylate monomer is between forty percent (40%) and eight-five percent (85%), inclusive, by weight of the adhesive. The methacrylic acid is between one percent (1%) and eight percent (8%), by weight of the adhesive. The first adhesive, second adhesive, third adhesive, and fourth adhesive consist of the same type of adhesive. Other embodiments include using similar yet different adhesives to secure each side of the rail to the post. The first side of the rail is opposite of the second side of the rail. The rail further comprises a top side, where the top side of the rail connects the first side of the rail to the second side of the rail.

A further embodiment of the current disclosure is a method of constructing a gate panel comprising the steps of securing a first shear block to a first end of a rail; securing a second shear block to a second end of the rail; inserting the first end of the rail, with the first shear block secured thereto, through an opening in a first post; securing the first shear block to the first post with an adhesive; inserting the second end of the rail, with the second shear block secured thereto, through an opening of the second post; and securing the second shear block to the second post with the adhesive. The first shear block is secured to the first end of the rail with a second adhesive, and wherein the second shear block is secured to the second end of the rail with the second adhesive. The second adhesive is a different type than the first adhesive. The adhesive is a methacrylate adhesive. The adhesive is a two-part methacrylate adhesive comprising a methyl methacrylate monomer and a methacrylic acid. The methyl methacrylate monomer is between forty percent (40%) and eight-five percent (85%), inclusive, by weight of the adhesive.

There has thus been outlined, rather broadly, certain embodiments of the invention in order that the detailed description thereof may be better understood, and in order that the present contribution to the art may be better appreciated. There are additional features that will be described hereinafter and which will form the subject matter of the claims appended hereto. The features listed herein and other features, aspects and advantages of the present disclosure will become better understood with reference to the following description and appended claims.

### BRIEF DESCRIPTION OF THE FIGURES

The accompanying drawings, which are incorporated in and form a part of this specification, illustrate embodiments of the disclosure and together with the description, serve to explain the principles of this invention.

FIG. 1 is an exploded view of a fence panel according to selected embodiments of the current disclosure.

FIG. 2 is a close-up exploded view of a fence and rail assembly according to selected embodiments of the current disclosure.

FIG. 3 is a side view of an assembled fence panel according to selected embodiments of the current disclosure.

FIG. 4 is an exploded view of a post and rail according to selected embodiments of the current disclosure.

### DETAILED DESCRIPTION OF THE INVENTION

Many aspects of the invention can be better understood with the references made to the drawings below. The components in the drawings are not necessarily drawn to scale. Instead, emphasis is placed upon clearly illustrating the components of the present invention. Moreover, like reference numerals designate corresponding parts through the several views in the drawings.

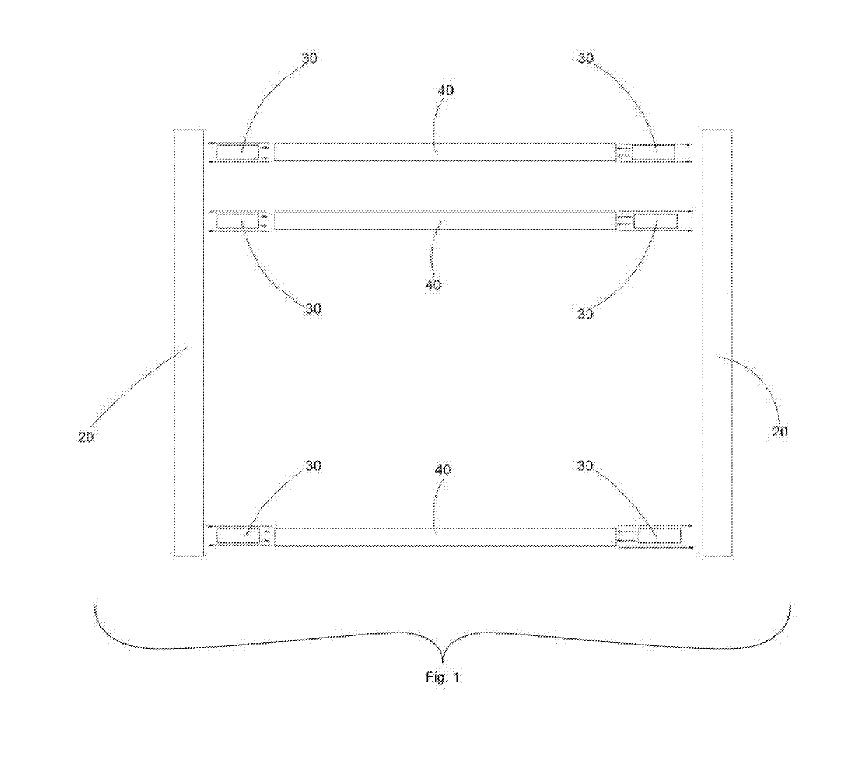

FIG. 1 is an exploded view of a fence panel according to selected embodiments of the current disclosure. Shear blocks 30 slide into each end of rails 40. The rails 40 with the shear blocks 30 secured therein are then secured to posts 20 by an adhesive.

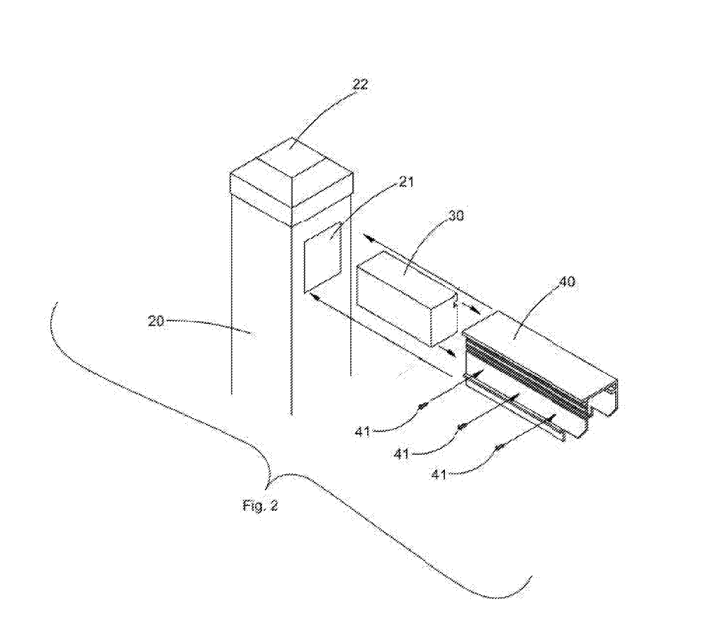

FIG. 2 is a close-up exploded view of a fence and rail assembly according to selected embodiments of the current disclosure. The main components of the rail and post assembly include a post 20, a rail 40, and a shear block 30. The shear block 30 mates with an end of a rail 40 and can be secured thereto by an adhesive. An adhesive may be used because of the extensive amount of surface area that is in contact between the shear block 30 and the rail 40. In another embodiment, fasteners 41, such as screws or bolts, are used to secure the rail 40 and shear block 30 together.

The post 20 includes an opening 20 that approximately matches the size and shape of the rail 40, such that the rail 40 may be positioned therethrough with minimal spacing between the rail 40 and the edge of the opening 21. Each end of the shear block includes a solid, flat surface. This flat surface provides a sufficient surface area to use an adhesive to secure the shear black to the rail. Accordingly, an adhesive is used to secure the shear block 30 to the post 20. In this manner, the rail 40 can be appropriately secured to the post 20 without welding the two parts together. In this view, a cap 22 is placed on top of the post 20.

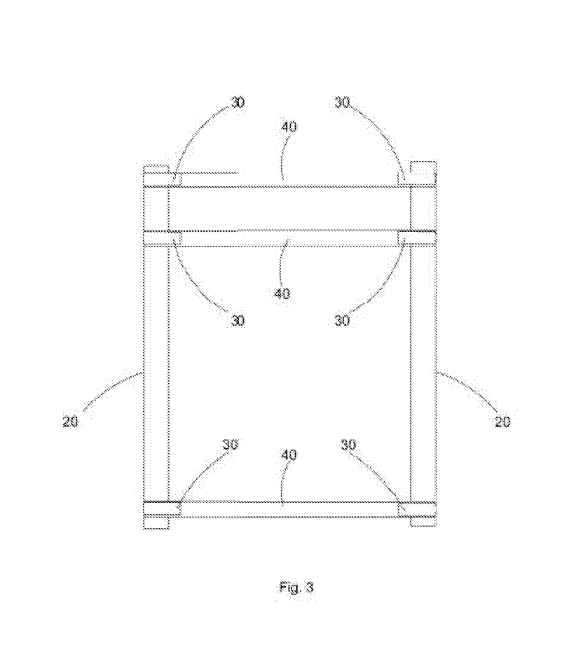

FIG. 3 is a side view of an assembled fence panel according to selected embodiments of the current disclosure. Each rail 40 includes two shear blocks 30, one located at each end. The shear blocks 30 are secured to the rails 40 as well as to a post 20 by means of an adhesive.

The adhesive used to secure the shear block to the post, rail, or both must be sufficiently strong to withstand shear loads, cantilever loads, tensile loads or a combination thereof encountered by normal use of an aluminum or similar material fence or gate panel. Particular embodiments of the current disclosure use a methacrylate adhesive. More specifically, a two-part methacrylate adhesive is used that comprises a methyl methacrylate monomer (stabilized) with a methacrylic acid. The methyl methacrylate monomer is between forty percent (40%) and eight-five percent (85%), inclusive, by weight. The methacrylic acid is between one percent (1%) and eight percent (8%), inclusive, by weight. Cured, the adhesive has a shear strength of more than 2800 pounds per square inch (PSI), and a tensile strength of more than 2500 PSI. It has an operating temperature range of negative sixty-seven degrees to two-hundred-fifty degrees, Fahrenheit. One such adhesive is produced by Adhesive Systems, Inc. of Frankfort, Ill. under the serial number MP55420.

In certain embodiments, the same adhesive that is used to secure the shear block to the post is also used to secure the shear block to the rail. In other embodiments, one adhesive is used to secure the shear block to the post while a second, different adhesive is used to secure the shear block to the rail.

The shape of the shear block should be such that it mates with the shape of the rail. For example, if the rail includes an internal tongue along its length, the shear block should include an external groove that mates with said tongue. Such a mating pair helps guide and place the shear block within the rail as well as provide additional contact surfaces for the transfer of forces between the rail and the shear block. Having the shear block and rail initially as two separate pieces allows for the shear block to be made of a different material than the rest of the rail. This is especially beneficial when design considerations require different strength materials to be used for the rail compared to the shear block.

A gate or fence panel according to selected embodiments may be constructed quickly and easily. Shear blocks are secured to each end of each rail. The shear block is secured to the rail through the use of an adhesive. The adhesive is applied to the side surfaces of the shear block, and then inserted into the rail, within six minutes of the application of the adhesive. A face of the shear block, that is one end of the shear block, should be flush with the end of the rail. As used herein, “flush” means within 0.125 inches of (either out from or into) the adjacent surface. Thus, the end of the shear block should extend out no more than 0.125 inches of the end of the rail as well as be no more than 0.125 inches within the rail. In an alternative embodiment, the shear block extends more than 0.125 inches out from the end of the rail. The adhesive is then allowed to cure for at least nine minutes.

The cure time may vary based upon the adhesive used. The cure time should be sufficiently long to allow the adhesive to properly set and hold the two components together. Furthermore, methods may be used to accelerate the curing of the adhesive thereby decreasing the cure time. For example, some adhesives cure at a faster rate when exposed to heat, but final strength may adversely be affected. Accordingly, particular embodiments of the current disclosure provide for cure times of less than nine minutes.

In another embodiment, each shear block is slid into the end of a rail, and secured in that position by one or more fasteners. These fasteners may be screws, nails, rivets, anchors, or other means well known in the art. As when using an adhesive to secure the shear block to the rail, a face of the shear block, that is one end of the shear block, should extend out of or be flush with the end of the rail; it should not be within the rail itself. Likewise, instead of fasteners, the shear block may be welded to the rail.

As discussed above, screws may be used to secure the shear block and rail together. However, leaving unfinished screws visible on the side of the rail may not be desirable. Therefore, a single sided snap cover (detachable fastener cover) to cover these fasteners and conceal them from view may be used, such as the one provided for in U.S. Pat. No. 8,317,164 to Ash, the entirety of which is incorporated by reference. The pivot knuckle design on the detachable fastener cover has dual plane snap ribs that move the snapping action to the bottom of the rail, thus freeing up an upper chamber to allow for securely snapping on this cover. The freeing up of the upper chamber allows for the placement of a picket fastener just under the rail web, which allows for maximum rackability. The knuckle provides for a drip edge for proper water shed, which resists water from wicking back into the inside of the rail.

The shear block may be secured to the rail before or after shipping the components of the fence panel. If the shear block is secured to the rail before shipment, the rails with secured shear blocks are placed into a box with two posts and adhesive to secure the shear blocks to the posts. This box is then shipped to the construction location via a package delivery company, such as United Parcel Service (UPS). Once the box with the parts arrives, the parts are removed and the panel is assembled. The rails are inserted into openings into the posts, and the adhesive is used to secure the shear blocks to the posts. In this manner, a fence or gate panel is inexpensively manufactured and shipped to a construction location where final assembly occurs.

After the shear block is secured within the rail, an adhesive is applied to the exposed end, or face, of the shear block. The rail (with the shear block) is inserted through an opening in the post. The opening should match the dimensions of the rail, such that the rail with shear block secured thereto will fit through the opening with little to no noticeable gap between the rail and post after the rail is inserted through the opening. The shear block is then pushed through the post until the end of the shear block with the adhesive comes into contact with the opposing inner surface of the post. The shear block should be abutting the inner surface of the post within six minutes of the application of adhesive to the end of the shear block. The shear block should then be held in place against the inner surface of the post for at least nine minutes to allow the adhesive to cure. After the adhesive has cured between the shear block and post, the panel may be installed as a part of a fence or gate.

Particular embodiments of the current disclosure provide for a shear block that abuts the inner surface of a post on one side, and extends through the opening in the opposing side of the post (of course, while within the rail). Other embodiments provide for a shear block that abuts the inner surface of a post on one side, but does not extend through the opening on the opposing side; in other words, the shear block is within the post while also being within the rail.

In a particular embodiment of the current disclosure, the rail, post, and shear block are each manufactured from aluminum. Nonetheless, other materials may be used as well, such as iron, steel, and plastics. Furthermore, different materials may be used for the different components. The shear block may be a different material than the rail. For example, the shear block may be made from stainless steel or plastic, while the rail itself is made from aluminum. Similarly, the fasteners, post cap, and post may be made from the same or different materials than the shear block and/or rail.

When constructing the panel, each end of the rail should have a shear block secured thereto such that each end of the rail is secured to a post. To reduce design and manufacturing costs, it is preferable that the same sized shear block may be used for either end of the rail. Thus, each end of the shear block should include a solid, flat face or end that provides sufficient surface area for the adhesive to adhere the shear block to the post. The rail may also be factory assembled to the shear blocks, thus becoming an assembly. This enables factories to produce the assembled shear blocks and rails during an off time, such as winter, in preparation for high-seasons, such as the spring time. However, the solid, flat surface need not be perpendicular to the surfaces of the sides of the shear block. In certain embodiments, each end or face of the shear block, while flat and solid, is also at an angle. This allows for the rail to be secured to the post at a non-perpendicular angle. The angled face of the shear block will be parallel to the inner surface of the post, but the rail extends away from the post at an angle other than ninety degrees, known as racking.

Each end of each rail is secured to a post according to the method above to form a panel. If the panel is being used as a gate, then hinges are affixed to one of the posts, such that the gate may be secured to another structure.

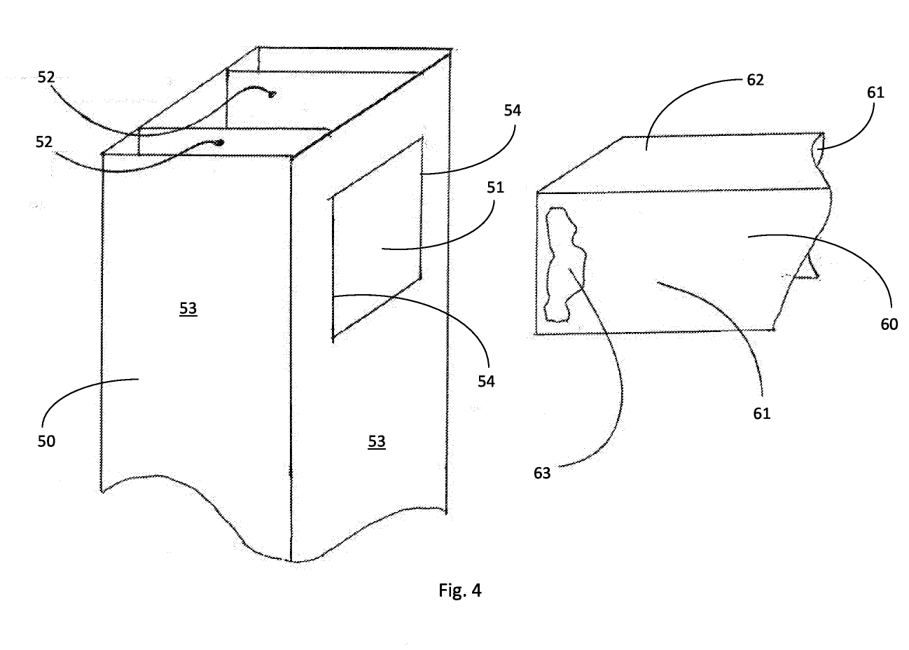

FIG. 4 is an exploded view of a post and rail according to selected embodiments of the current disclosure. In this figure, a rail is secured to a post using an adhesive, but without the use of a shear block. The post 50 includes external walls 53 and two internal walls 52. There is an opening 51 in one of the external walls 53 of the post 50. One side 54 of the opening 51 is adjacent to one of the internal walls 52, while another side 54 of the opening 51 (the opposite side in the embodiments shown in this figure) is adjacent to the other of the internal walls 52. The rail 60 has three sides, specifically two sides 61 and a top side 62 that connect the two sides 61 together. An adhesive 63 is applied to one or more sides 61 of the rail 60, towards the end of the rail. When the rail is inserted into the opening, the surface of each side 61 of the rail is adjacent to one of the internal walls 52 of the post 50. The adhesive 63 comes in contact with the internal wall 52 and (upon curing) secures the side 61 of the rail 60 to the internal wall 52 of the post 50, thereby securing the rail 60 to the post 50.

To assemble the post and rail together, an adhesive is applied to one or more sides, and in particular embodiments, two sides, of the leading edge, or end, of the rail. The end of the rail is then inserted through the opening in the post such that the sides of the rail are adjacent to the internal walls of the post and the adhesive secures the sides of the rail to the internal walls of the post. Certain embodiments provide for inserting the rail through the opening until the end of the rail comes in contact with the back (or opposing) wall of the post, while other embodiments provide for the rail only extending partially through the post.

The rail and post assembly discussed above teaches two internal walls with an adhesive on both sides of the rail; however, other embodiments of the current disclosure provide for a single internal wall of the post with an adhesive securing only a single side of the rail to that internal wall. The internal side walls of the post need not extend along the entire length of the post; however, such a configuration may be advantageous if the post is manufacturing using extrusion methods.

A further embodiment of the current disclosure includes a post with an opening, no internal walls along with a rail without a shear block. Similar to the embodiment described in FIG. 4, the rail is secured to the post using an adhesive. However, instead of utilizing internal walls, the opening in the post spans almost the entire width of the post. Likewise, the width of the rail corresponds to the size and shape of the opening such that the sides of the rail are adjacent to the inner side of the external walls of the post. An adhesive is used to secure a side of the rail to the inner side of the external wall of the post.

While various embodiments of the present disclosure have been described above, it should be understood that they have been presented by way of example only, and not of limitation. Likewise, the various diagrams may depict an example architectural or other configuration for the disclosure, which is provided to aid in understanding the features and functionality that can be included in the invention. The invention is not restricted to the illustrated example architectures or configurations, but the desired features can be implemented using a variety of alternative architectures and configurations.

Indeed, it will be apparent to one of skill in the art how alternative functional configurations can be utilized to implement the desired features of the present invention. Additionally, with regard to flow diagrams, operational descriptions and method claims, the order in which the steps are presented herein shall not mandate that various embodiments be implemented to perform the recited functionality in the same order unless the context dictates otherwise.

Although the disclosure herein is described in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments, whether or not such embodiments are described and whether or not such features are presented as being a part of a described embodiment. Thus, the breadth and scope of the present invention should not be limited by any of the above-described exemplary embodiments.

That which is claimed:

1. A rail and post assembly comprising
a post, a rail, a shear block, and an adhesive, where the adhesive secures the shear block to the post, where the post comprises an opening, where the size and shape of the opening is sufficient to allow the rail to extend therethrough, where the shear block is secured to the rail.

2. The rail and post assembly of claim 1, where the shear block is secured to the rail with the adhesive.

3. The rail and post assembly of claim 1, wherein the adhesive is a methacrylate adhesive.

4. The rail and post assembly of claim 1, wherein the adhesive is a two-part methacrylate adhesive comprising a methyl methacrylate monomer and a methacrylic acid.

5. The rail and post assembly of claim 4, wherein the methyl methacrylate monomer is between forty percent (40%) and eight-five percent (85%), inclusive, by weight of the adhesive.

6. The rail and post assembly of claim 4, wherein the methacrylic acid is between one percent (1%) and eight percent (8%), by weight of the adhesive.

7. A rail and post assembly comprising
a post, where the post comprises a first internal wall, a second internal wall, and an opening, where a first side of the opening is adjacent to the first internal wall, and where a second side of the opening is adjacent to the second internal wall;
a rail, where the rail comprises a first side and a second side, where an end of the rail extends through the opening of the post;
a first adhesive, where the first adhesive secures the first side of the rail to the first internal wall of the post; and
a second adhesive, where the second adhesive secures the second side of the rail to the second internal wall of the post.

8. The rail and post assembly of claim 7, wherein the first adhesive and second adhesive are each a methacrylate adhesive.

9. The rail and post assembly of claim 7, wherein the first adhesive and second adhesive area each a two-part methacrylate adhesive comprising a methyl methacrylate monomer and a methacrylic acid.

10. The rail and post assembly of claim 9, wherein the methyl methacrylate monomer is between forty percent (40%) and eight-five percent (85%), inclusive, by weight of the adhesive.

11. The rail and post assembly of claim 9, wherein the methacrylic acid is between one percent (1%) and eight percent (8%), by weight of the adhesive.

12. The rail and post assembly of claim 7, wherein the first adhesive and the second adhesive consist of the same type of adhesive.

13. The rail and post assembly of claim 7, wherein the first side of the rail is opposite of the second side of the rail.

14. The rail and post assembly of claim 13, wherein the rail further comprises a top side, where the top side of the rail connects the first side of the rail to the second side of the rail.

15. A method of constructing a gate panel comprising
securing a first shear block to a first end of a rail;
securing a second shear block to a second end of the rail;
inserting the first end of the rail, with the first shear block secured thereto, through an opening in a first post;
securing the first shear block to the first post with an adhesive;
inserting the second end of the rail, with the second shear block secured thereto, through an opening of the second post; and
securing the second shear block to the second post with the adhesive.

16. The method of claim 15, wherein the first shear block is secured to the first end of the rail with a second adhesive, and wherein the second shear block is secured to the second end of the rail with the second adhesive.

17. The method of claim 16, where the second adhesive is a different type than the first adhesive.

18. The method of claim 15, wherein the adhesive is a methacrylate adhesive.

19. The method of claim 15, wherein the adhesive is a two-part methacrylate adhesive comprising a methyl methacrylate monomer and a methacrylic acid.

20. The method of claim 19, wherein the methyl methacrylate monomer is between forty percent (40%) and eight-five percent (85%), inclusive, by weight of the adhesive.
